(19) United States
(12) Patent Application Publication
(10) Pub. No.: US 2022/0115672 A1
(43) Pub. Date: Apr. 14, 2022

(54) Method for Hydrophilicizing a Semifinished Element, and Electrode Element, Bipolar Element or Heat Exchanger Element Produced Thereby

(71) Applicant: Fraunhofer-Gesellschaft zur Förderung der angewandten Forschung e.V., Muenchen (DE)

(72) Inventors: Lukas Kopietz, Duisburg (DE); Jens Burfeind, Oberhausen (DE); Christian Doetsch, Oberhausen (DE); Anna Grevè, Essen (DE); Peter Schwerdt, Dinslaken (DE)

(21) Appl. No.: 17/430,468

(22) PCT Filed: Feb. 13, 2020
(86) PCT No.: PCT/EP2020/053710

§ 371 Date: Aug. 12, 2021

(30) Foreign Application Priority Data
Feb. 13, 2019 (DE) 10 2019 103 542.2

(51) Int. Cl. H01M 4/66; C01B 32/05; C08J 7/06; C01B 32/15; B05D 1/06; B05D 1/10; B05D 5/08; B05D 7/02; H01B 1/24

(52) U.S. Cl. CPC H01M 4/668; C01B 32/05; C08J 7/06; C01B 32/15; B05D 1/06; B05D 2201/02; B05D 5/08; B05D 7/02; H01B 1/24; C01P 2006/12; C01P 2006/19; B05D 1/10

(57) ABSTRACT

The invention relates to a method for hydrophilicizing a semi-finished element, in particular an electrode element, a bipolar element and/or a heat exchanger element, made of a plastic material or plastic composite material containing at least one thermoplastic and/or at least one thermosetting plastic. In order that the wettability of the component surface for aqueous media can be increased with smaller structure changes, with lower costs and with less effort, provision is made for the hydrophilicizing to be caused at least partially by applying carbon particles at least in sections on at least one surface of the semi-finished element and the carbon particles to be applied by rubbing, pressurised gas jet and/or by electrostatics at least in sections on the at least one surface in such manner that the carbon particles remain adhered to the surface.

### CROSS-REFERENCE TO RELATED APPLICATIONS

This application is the United States national phase of International Application No. PCT/EP2020/053710 filed Feb. 13, 2020, and claims priority to German Patent Application No. 10 2019 103 542.2 filed Feb. 13, 2019, the disclosures of which are hereby incorporated by reference in their entirety.

### BACKGROUND OF THE INVENTION

### Field of the Invention

The invention relates to a method for hydrophilicizing a semi-finished element, in particular an electrode element, a bipolar element and/or a heat exchanger element, made of a plastic material or plastic composite material containing at least one thermoplastic and/or at least one thermosetting plastic. Further, the invention relates to a method for manufacturing an electrode element, in particular an electrode plate, a bipolar element, in particular a bipolar plate, and/or a heat exchanger element, in particular a heat exchanger tube or a heat exchanger plate, from a semi-finished element. Additionally, the invention relates to an electrode element manufactured as described herein as well as an electrochemical cell with an electrode element as described herein.

Electrode elements and bipolar elements require a sufficient electrical conductivity which is why known electrode elements and bipolar elements are formed either from a metallic material or a composite material with at least one electrically conductivity component. In contrast, in the case of heat exchanger elements, an electrical conductivity is normally unnecessary. However, there is the need here for high thermal conductivity. Since materials with a high electrical conductivity usually also conduct heat well, heat exchanger elements are also often formed from a metallic material or a composite material with at least one electrically conductive component. A further commonality between electrode elements and bipolar elements, on the one hand, and heat exchanger elements, on the other hand, is that both the heat and the electrical power should be conducted as evenly distributed as possible over the entire cross-section of the respective element due to the corresponding line resistances. If composite materials are used to manufacture the corresponding components, which, for whatever reasons, have a not insignificant amount of plastic, typically fine, conductive particles are distributed in the plastic in order to ensure the necessary electrical or thermal conductivity. In the case of the corresponding composite materials, a matrix of at least one plastic or of a mixture of plastics is then usually formed in which the conductive particles are absorbed in a finely distributed manner. This matrix consequently forms the continuous phase in which the conductive particles are dispersed in a finely distributed manner and as homogenously as possible. The conductive particles are for example metallic or carbon-based particles, since these materials have an increased electrical and thermal conductivity compared to the at least one plastic.

In the case of semi-finished elements, for instance in the form of electrode elements, bipolar elements and heat exchanger elements, which are formed from a composite material, whose continuous phase has at least one plastic, there is in part the fundamental problem of a limited wettability of the surface for water or aqueous media. This is in particular the case when using hydrophobic plastics to form the semi-finished elements, and it must be noted that most of the widely used thermoplastic and thermosetting plastics are proportionally hydrophobic. If the filler material particles are also hydrophobic, which is often the case with carbon-based filler material particles, the problem of the limited wettability is increased further for aqueous media. Hydrophobic surfaces have namely the tendency to repel water or aqueous media or to reduce the contact area between the surface and the water or the aqueous media, whereas water or aqueous media are attracted and thus spread extensively on the surface, i.e. they wet the surface.

Good wettability for aqueous media is of particular importance for electrode elements and bipolar elements, since these semi-finished elements should enter into contact with hydrophilic electrolytes over their full surface as far as possible. The same applies to heat exchanger elements which should absorb heat from an aqueous medium and/or discharge heat to an aqueous medium. Such a full-surface contact can essentially also be achieved with hydrophobic materials by suitable handling of the electrolytes or of the at least one medium involved in the heat exchange. However, this then still results in increased transition resistances on the boundary surface between the electrode element, the bipolar element or the heat exchanger element, on the one hand, and the adjoining aqueous medium, on the other hand, which ultimately have an impact as line or transition resistances on the corresponding boundary surfaces for the conduction of the electrical power or for the conduction of the heat to be transferred.

The wettability or the hydrophilic properties of semi-finished products are in particular of importance when the semi-finished products are intended to form electrode elements, bipolar elements or heat exchanger elements. In this case, electrode elements or bipolar elements are for example used in electrochemical cells such as fuel cells or redox flow batteries.

Redox flow batteries are already known in different embodiments. Such embodiments are for example described in AT 510 250 A1 and US 2004/0170893 A1. An important advantage of the redox flow batteries is their suitability to be able to store very large amounts of electrical energy. The energy is in this case stored in electrolytes which can be held in very large tanks in a space-saving manner. The electrolytes usually have metallic ions of different oxidation states. In order to withdraw electrical energy from the electrolytes or to recharge them, the electrolytes are pumped through what are known as electrochemical cells. The cells are in this case formed by two half-cells which are separated from one another by a membrane and each comprise a cell interior, an electrolyte and an electrode or a bipolar plate. The membrane is semi-permeable and has the task of spatially and electrically separating cathode and anode of an electrochemical cell from one another. To do this, the membrane must be permeable to certain ions, which cause the conversion of the stored chemical energy into electrical energy. Redox reactions take place at the electrodes or bipolar plates of the cell, with electrons being released from the electrolytes at an electrode and electrons being absorbed at the other electrode. The metallic and/or non-metallic ions of the electrolytes form redox pairs and as a result generate a redox potential. As redox pairs, iron-chromium, polysulfide-bromide, vanadium or other heavy metals are for example considered. These or also other redox pairs can essentially be present in aqueous or non-aqueous solution. However, redox-active organic substances, such as for example anthraquinone, are also considered as the electrolytes.

The electrodes of a cell, between which a potential difference is formed as a result of the redox potentials, are electrically connected to one another outside of the cell, e.g. by an electrical load. While the electrons outside of the cell move from one half-cell to another, ions of the electrolytes pass through the membrane directly from one half-cell to another half-cell. To recharge the redox flow battery, a potential difference can be applied to the electrodes of the half-cells, instead of the electrical load, for example by means of a charging device, by way of which the redox reactions taking place at the electrodes of the half-cells can be reversed.

If necessary, a number of identical cells is combined in a redox flow battery. The cells are usually stacked one on top of another, which is why the entirety of the cells are also designated as a cell pile or a cell stack. The individual cells are usually flowed through by the electrolytes parallel to one another, while the cells are usually electrically connected in succession. The cells are thus usually connected hydraulically parallel and electrically in series. In this case, the charge status of the electrolytes is the same in one of each of the half-cells of the cell stack.

While electrode elements or bipolar elements of electrochemical cells, in particular to form cell stacks, are formed in a plate-shaped manner for the sake of simplicity, plate-shaped and tubular heat exchanger elements in particular are also considered for heat exchanger elements. Plate heat exchangers and tube bundle heat exchangers using corresponding heat exchanger elements are known in different configurations.

Against the background already described of the partially lacking wettability or hydrophily of the semi-finished products used, in particular of the electrode elements, bipolar elements or heat exchanger elements, different methods have been proposed for hydrophilicizing surfaces of semi-finished elements. Thus, a chemical surface treatment is for example known, in which the surfaces are etched with diluted acids. Pickling of the surfaces is also mentioned in this case, which leads to the accumulation of hydrophilic groups, for instance of oxide groups or oxyl groups such that the surface as a whole is more hydrophilic and therefore can be wetted better. Furthermore, it is known to fluorinate the surfaces of the components, with fluorine being deposited in the surfaces under high pressure and increased temperature. The fluorine atoms lead to many small charge displacements locally on the surface of the components, whereby the surface as a whole is more hydrophilic. The surfaces of corresponding components can alternative also be brought into contact with a plasma or corona beam. The corresponding bombardment of the surface with electrical charge excites the surface into a chemical change of the surface structure which is more hydrophilic than the original surface structure.

However, all these methods have the disadvantage that they are very complex and therefore expensive. In addition to this, the surface treatment leads to a change of the structure, in particular to an undesired crystallisation or recrystallization on the surface of the plastic. The reason for this is for example the heat effect on the component surface and/or the chemical modification of the surface structure. Excess crystallisation of the plastic on the component surface generally unfavourably affects the mechanical properties of the components.

Therefore, the object underlying the present invention is to design and further develop the method mentioned at the outset and previously described in detail in such manner that the wettability of the component surface for aqueous media can be increased with smaller structure changes, with lower costs and with less effort.

This object is achieved as described herein by a method for hydrophilicizing a semi-finished element, in particular an electrode element, a bipolar element and/or a heat exchanger element, made of a plastic material or plastic composite material containing at least one thermoplastic and/or at least one thermosetting plastic,
in the case of which the hydrophilicizing is caused at least partially by applying carbon particles at least in sections on at least one surface of the semi-finished element and
in the case of which the carbon particles are applied by rubbing, pressurised gas jet and/or by electrostatics at least in sections on the at least one surface in such manner that the carbon particles remain adhered to the surface.

The mentioned object is also achieved as described herein by a method for manufacturing an electrode element, in particular an electrode plate, a bipolar element, in particular a bipolar plate, and/or a heat exchanger element, in particular a heat exchanger tube or a heat exchanger plate, from a semi-finished element,
in the case of which a semi-finished element hydrophilicized as described herein is further processed into an electrode element, in particular an electrode plate, a bipolar element, in particular a bipolar plate, and/or a heat exchanger element, in particular a heat exchanger tube or a heat exchanger plate, and/or
in the case of which a semi-finished element is further processed into an electrode element, in particular an electrode plate, into a bipolar element, in particular a bipolar plate, and/or into a heat exchanger element, in particular a heat exchanger tube or a heat exchanger plate, and then is hydrophilicized as described herein.

The previously mentioned object is also achieved as described herein by an electrode element, in particular an electrode plate, a bipolar element, in particular a bipolar plate, and/or a heat exchanger element, in particular a heat exchanger tube or heat exchanger plate, manufactured as described herein.

Otherwise, the previously mentioned object is achieved as described herein by an electrochemical cell, in particular a redox flow battery, with an electrode element, in particular an electrode plate, or with a bipolar element, in particular a bipolar plate, as described herein.

The invention has thus recognised that the surface of a semi-finished element, in particular of an electrode element, of a bipolar element and/or of a heat exchanger element, can be hydrophilicized by the surface being treated with a hydrophobic, carbon-based, particulate material, which is also designated here generally as carbon particles. Since these carbon particles, such as for example carbon black or graphite, are very cheap and the surface can also be treated very easily with the carbon-based materials by rubbing, pressurised gas jet and/or by electrostatics, hydrophilicizing the surface requires neither complex methods nor expensive materials. In addition, the surface, aside from with the carbon particles, does not have to be treated with any other aggressive chemicals or chemicals that otherwise modify the surface structure. Similarly, the treatment of the surface with carbon particles does not require an increase in temperature of the component. The treatment of the surface consequently preferably takes place at room temperature.

“Hydrophilic” is understood in the present case as a relative material property in comparison to the untreated surface, with water or an aqueous medium being easily spread on the surface, in particular when it is flat and horizontally aligned. The “hydrophilization” is accordingly understood as a measure which imparts hydrophilic or more hydrophilic properties to a surface in comparison to the untreated surface. The “wettability” or “ability to moisten” here expresses how easily water or an aqueous medium displaces air adjoining the surface of the component. The wettability of a surface can be categorised by measuring the contact angle or the angle formed at the contact line between a drop and a surface. In the case of contact angles of less than 90 degrees, a surface is generally considered hydrophilic and in the case of angles greater than 90 degrees generally designated as hydrophobic.

The contact angle of liquids on solid surfaces is measured either statically or dynamically. Static contact angles are typically measured on opposing sides of a stationary drop.

Dynamic contact angles can be measured using different methods, in particular using the Wilhelmy method, which uses a dip method to determine advancing and retreating contact angles. The surface is in this case dipped into water or an aqueous liquid or an aqueous medium and the contact angle is determined when the surface is immersed into the liquid (advancing contact angle) or when the surface is removed from the aqueous liquid or the aqueous medium (retreating contact angle).

The carbon particles, which consist at least substantially of carbon, as previously mentioned, i.e. can, but do not have to, be formed by pure carbon, can if necessary be applied on the surface to be treated by rubbing; this occurs, for the sake of better reproducibility and adjustability, preferably by machine, by a stamp, plate or the like, which is moved at a predefined pressure and at predefined movement over the surface. In this case, the carbon particles to be rubbed in can be applied, in particular scattered, onto the surface prior to being rubbed in and/or while being rubbed in.

Alternatively or additionally, the carbon particles can also be applied by means of pressurised gas jet onto the surface to be treated. The carbon particles are fired in this process pneumatically onto the surface to be treated by means of a carrier gas. The carrier gas is in this case preferably air for the sake of simplicity. Pressurised air jet is also meant when using air. These methods are known in different configurations using sand instead of carbon particles for instances as what is known as sandblasting.

A further possibility is to apply the carbon particles by means of electrostatics onto the surface to be treated which can take place instead of or in addition to one of the aforementioned methods. In order to utilise the electrostatic attraction, the surface to be treated can be provided with an excess of positive or negative charge and the carbon particles can be provided with an opposing excess charge. Then, the surface to be treated and the carbon particles are brought together and then attract each other as a result of the respectively opposing excess charges such that the carbon particles remain adhered to the surface.

Components are typically designated as semi-finished products, when they are not goods or end products to be manufactured using the semi-finished products. Semi-finished products are therefore also designated as workpieces or semi-finished goods. In the present case, when using the designation semi-finished product, however, it must be considered that the differences between the terms semi-finished product and goods or end products, on the one hand, and between the terms semi-finished element, electrode element, bipolar element and heat exchanger element are fluid. A semi-finished element can for example be a still unfinished electrode element, bipolar element and heat exchanger element which still requires at least one further production step in order to be able to be used as a finished electrode element, bipolar element and heat exchanger element and namely regardless of a hydrophilicizing of a surface. The step of hydrophilicizing may be necessary as a further production step.

A semi-finished element can in the present case, however, also be an electrode element, a bipolar element and a heat exchanger element which would essentially already be usable as such. However, if the step of hydrophilicizing by applying carbon particles has not yet taken place, the corresponding component still requires this hydrophilicizing step to become an electrode element, bipolar element and heat exchanger element according to the invention or in order to conclude the method according to the invention. The corresponding components thus concern semi-finished elements and less so electrode elements, bipolar elements and heat exchanger elements since these have not yet passed through a production step, although corresponding components would nevertheless be usable as electrode elements, bipolar elements and heat exchanger elements even though disadvantages would have to be accepted in this case.

These contexts are discernible to the person skilled in the art. Additionally, it is clearly discernible to the person skilled in the art from the context what is meant in each case individually by a semi-finished element. The person skilled in the art can thus for example, and if necessary, discern whether the semi-finished element can, must or should not be a semi-finished element that can already be used for the intended use. The person skilled in the art can similarly for example, and if necessary, discern whether the electrode element, bipolar element and heat exchanger element can, must or should not be a semi-finished element.

For the sake of better understandability and to avoid unnecessary repetitions, the methods, the electrode element and the electrochemical cell are additionally described below together without distinguishing in each case individually between the methods, the electrode element and the electrochemical cell. However, it is apparent to the person skilled in the art from the context in each case which feature is in each case particularly preferred in relation to the methods, the electrode element and the electrochemical cell.

In the case of a first particularly preferred configuration of the method, the excess carbon particles are at least predominantly removed from the at least one surface by tapping, shaking, blowing, rinsing and/or wiping after applying carbon particles by rubbing, pressurised gas jet and/or by electrostatics. In this way, the carbon particles, which did not enter into a sufficiently solid connection with the surface as a result of applying the carbon particles, can once again be easily removed from the surface. The removed carbon particles can then be reused to treat another surface and/or the removed carbon particles do not negatively affect the further use of the hydrophilicized electrode element, bipolar element and/or heat exchanger element.

Graphite, graphene, carbon nano tubes (CNTs), carbon black and/or carbon fibres can be particularly expediently used as carbon particles for hydrophilicizing the surface to be treated. These particles are namely themselves hydrophobic, but generate very good wettability when applied to the surface to be hydrophilicized. Additionally, these carbon particles are cost-effective to obtain and easy to handle.

In order to obtain a suitable structure or a suitable degree of crystallisation of the at least one thermoplastic and/or of the at least one thermosetting plastic, in particular the hydrophilicized surface, after applying the carbon particles onto the surface to be treated, the surface to be treated is hydrophilicized with carbon particles preferably at a temperature of between 0° C. and 50° C. However, in many cases a temperature of between 5° C. and 40° C., in particular between 10° C. and 30° C., is particularly preferred depending on the plastic used.

The wettability of the surface to be treated is increased to a particular degree by applying the carbon particles if, after applying to the hydrophilicized surface, in particular after removing the carbon particles from the hydrophilicized surface, the grammage of the carbon particles of the surface is at least in sections less than 10,000 mg/m², preferably less than 1,000 mg/m², in particular less than 500 mg/m².

There is also essentially a positive effect if the carbon particles are proportionally small. Thus, good wettability is obtained if at least 90% by weight of the carbon particles are smaller than 100 μm, preferably smaller than 10 μm, in particular smaller than 0.1 μm.

However, there is also essentially a positive effect if the carbon particles have a large specific surface. Thus, carbon particles with a BET surface of between 50 m²/g and 10,000 m²/g, preferably between 250 m²/g and 2,500 m²/g, in particular between 500 m²/g and 1800 m²/g, are particularly preferred.

Similarly, such carbon particles are particularly suitable for increasing the wettability which have an oil adsorption number (ISO 4656:2012-07) of between 10 ml/100 g and 1000 ml/100 g, in particular between 50 ml/100 g and 500 ml/100 g, in particular between 100 ml/100 g and 300 ml/100 g.

As the at least one thermoplastic, alternatively or additionally, a plastic can be used selected from the group of polyolefins (e.g. polyethylene (PE), polypropylene (PP)), poly sulfides and poly sulfones (e.g. polyphenylene sulfide (PPS), polysufone (PSU)), poly aryl ether ketones (e.g. poly ether ketone (PEK) and polyether ether ketone (PEEK)) and/or fluoroplastics (e.g. polytetrafluoroethylene (PTFE), polyvinylidene fluoride (PVDF)). These plastics can also be easily treated with the carbon particles. Otherwise, the wettability of these rather hydrophobic plastics can be increased to a particular extent using the described method.

As the at least one thermosetting plastic, preferably a plastic can also be used selected from the group of reaction resins (e.g. unsaturated polyester resins (UP resins), epoxide resins (EP resins), isocyanate resins, methacrylate resins (MA resins), phenacrylate resins (PHA resins) and/or condensation resins (e.g. phenol resins, amino resins, polyester resins).

A suitable electrical or thermal conductivity, on the one hand, and good wettability, on the other hand, can be obtained for such electrode elements, bipolar elements and/or heat exchanger elements which have a proportion of a, in particular electrically conductive, filler material of between 25% by volume and 97% by volume, preferably between 45% by volume and 88% by volume, in particular between 53% by volume and 70% by volume, of the plastic composite material.

In this case, due to the properties of the electrode elements, bipolar elements and/or heat exchanger elements, it is particularly preferred if the at least one filler material at least substantially corresponds to the carbon particles. This applies to a particular extent if the carbon particles are graphite, graphene, carbon nano tubes, carbon black and/or carbon fibres. Thus, it preferably concerns an at least substantially similar material. Alternatively or additionally, filler material and carbon particles can also have differences in terms of the particle size, of the BET surface, of the oil adsorption number, of the composition or the like. It is particularly expedient here if at least one filler material of the plastic composite material is formed as carbon particles.

The previously mentioned advantages of hydrophilicizing have a particular effect if the electrode element is an electrode plate, the bipolar element is a bipolar plate, and/or the heat exchanger element is a heat exchanger tube or a heat exchanger plate. Corresponding components benefit from a more hydrophilic surface, are widely used and can also be easily hydrophilicized.

The wettability has also an, in particular, advantageous effect when the electrode element is an electrode element of a redox flow battery or when the bipolar element is a bipolar element of a redox flow battery. In the case of these components, good wettability matters so as to produce redox flow batteries with high power densities.

### BRIEF DESCRIPTION OF THE DRAWINGS

The invention is explained in more detail below on the basis of a drawing merely representing exemplary embodiments. In the drawing is shown:

FIG. 1 the hydrophilicizing according to the invention of a surface of a semi-finished element by rubbing in a schematic side view,

FIG. 2 the hydrophilicizing according to the invention of a surface of a semi-finished element by pressurised gas jet in a schematic side view, and

FIG. 3 the hydrophilicizing according to the invention of a surface of a semi-finished element by electrostatics in a schematic side view.

### DESCRIPTION OF THE INVENTION

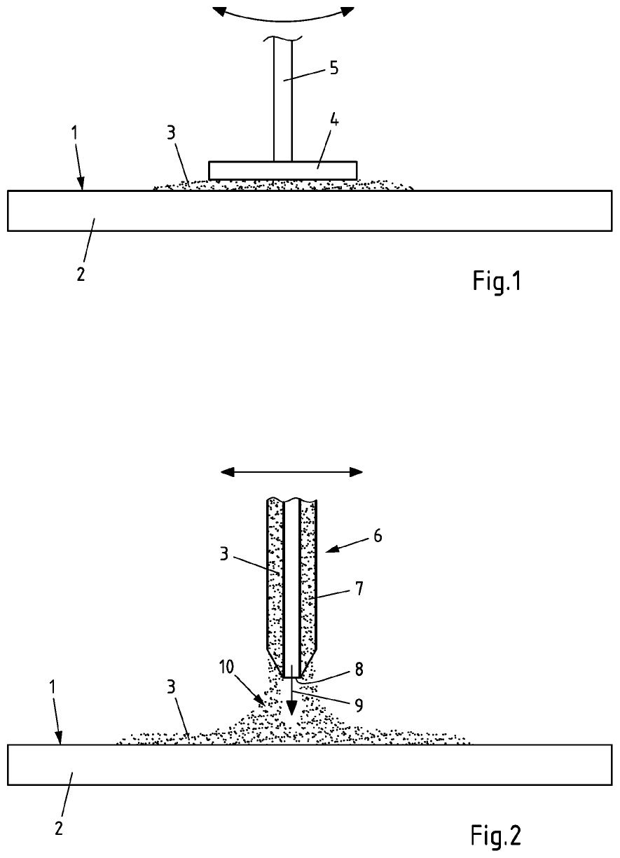

In FIG. 1, a method is schematically represented for hydrophilicizing a surface 1 to be treated of a flat semi-finished element 2, in particular of an electrode element, of a bipolar element and/or of a heat exchanger element, by rubbing in carbon particles 3, in particular in the form of graphite, graphene, carbon nano tubes, carbon black and/or carbon fibres. To do this, a rubbing element 4, for instance in the form of a stamp or plate, is moved over the surface 1 to be treated and namely preferably back and forth, with circular movements being particularly recommended. For the sake of simplicity, the rubbing element 4 can be driven by motor and be connected to the drive, not represented, via a rod element 5. In one possible configuration, the carbon particles 3 to be rubbed in can be guided to the surface 1 to be treated via a hollow rod element 5 and a central opening in the rubbing element 4. The carbon particles 3 applied to the surface 1 to be treated by the rubbing element 4 under a preferably adjustable pressure partially penetrate into the plastic of the surface 1 and thus remain adhered to the surface 1.

In FIG. 2, a method is schematically represented for hydrophilicizing a surface 1 to be treated of a flat semi-finished element 2, in particular of an electrode element, of a bipolar element and/or of a heat exchanger element, by pressurised gas jet of carbon particles 3, in particular in the form of graphite, graphene, carbon nano tubes, carbon black and/or carbon fibres. In this process, a two-substance nozzle 6 is moved over the surface 1 to be treated and namely preferably back and forth, with circular movements being particularly recommended. The carbon particles 3 are introduced via the two-substance nozzle 6 by way of an outer annual channel 7 and are entrained by a pressurised gas current 9, in particular by a pressurised air current, flowing out via a central opening 8. In this way, a jet 10 of carbon particles 3 is generated, which impinges upon the surface 1 to be treated at high speed such that the carbon particles 3 applied in this manner partially penetrate into the plastic of the surface 1 and thus remain adhered to the surface 1.

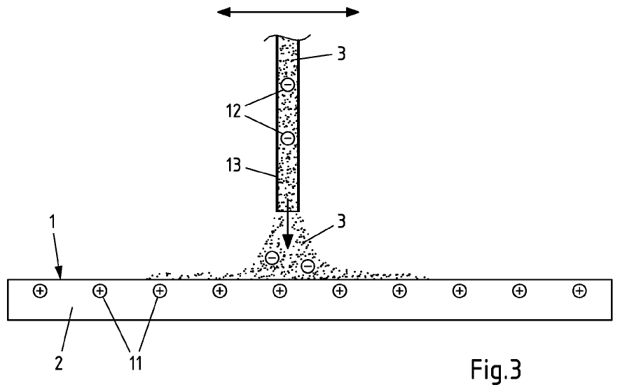

In FIG. 3, a method is schematically represented for hydrophilicizing a surface 1 to be treated of a flat semi-finished element 2, in particular of an electrode element, of a bipolar element and/or of a heat exchanger element, by electrostatic attraction of carbon particles 3, in particular in the form of graphite, graphene, carbon nano tubes, carbon black and/or carbon fibres. In this process, a charge, here a positive charge 11, is first applied to the surface 1 to be treated of the semi-finished element 2 which ensures a positive excess charge on the surface 1 of the semi-finished element 2. In contrast, a negative charge 12 has been applied to the carbon particles 3 and they have been introduced into a channel 13 from which the carbon particles 3 trickle out as a result of the potential difference and remain adhered partially electrostatically to the surface 1 to be hydrophilicized. In order to apply the carbon particles 3 extensively on the surface 1, the channel 13 with the carbon particles 3 can be moved over the surface 1 to be treated and namely preferably back and forth, with circular movements being particularly recommended.

1. A method for hydrophilicizing a semi-finished element, in particular an electrode element, a bipolar element and/or a heat exchanger element, made of a plastic material or plastic composite material containing at least one thermoplastic and/or at least one thermosetting plastic,
in the case of which the hydrophilicizing is caused at least partially by applying carbon particles at least in sections on at least one surface of the semi-finished element and
in the case of which the carbon particles are applied by rubbing, pressurised gas jet and/or by electrostatics at least in sections on the at least one surface in such manner that the carbon particles remain adhered to the surface.

2. The method according to claim 1, in the case of which, after applying carbon particles on the at least one surface for hydrophilicizing the semi-finished element, the excess carbon particles are removed at least predominantly from the at least one surface by tapping, shaking, blowing, rinsing and/or wiping.

3. The method according to claim 1, in the case of which carbon particles in the form of graphite, graphene, carbon nano tubes, carbon black and/or carbon fibres are used for hydrophilicizing.

4. The method according to claim 1, in the case of which hydrophilicizing takes place with carbon particles at a temperature of between 0° C. and 50° C., preferably between 5° C. and 40° C., in particular between 10° C. and 30° C.

5. The method according to claim 1, in the case of which, after applying the carbon particles on the at least one surface to be hydrophilicized, in particular after removing the carbon particles from the hydrophilicized surface, the grammage of the carbon particles on the surface is at least in sections less than 10,000 mg/m², preferably less than 1,000 mg/m², in particular less than 500 mg/m².

6. The method according to claim 1, in the case of which at least 90% by weight of the carbon particles are smaller than 100 μm, preferably smaller than 10 μm, in particular smaller than 0.1 μm.

7. The method according to claim 1, in the case of which the carbon particles have a BET surface of between 50 m²/g and 10,000 m²/g, preferably between 250 m²/g and 2,500 m²/g, in particular between 500 m²/g and 1800 m²/g.

8. The method according to claim 1, in the case of which the oil adsorption number (ISO 4656:2012-07) of the carbon particles is between 10 ml/100 g and 1000 ml/100 g, in particular between 50 ml/100 g and 500 ml/100 g, in particular between 100 ml/100 g and 300 ml/100 g.

9. The method according to claim 1, in the case of which the at least one thermoplastic is selected from the group of polyolefins (e.g. polyethylene (PE), polypropylene (PP)), poly sulfides and poly sulfones (e.g. polyphenylene sulfide (PPS), polysulfone (PSU)), poly aryl ether ketones (e.g. poly ether ketone (PEK) and polyether ether ketone (PEEK)) and/or fluoroplastics (e.g. polytetrafluoroethylene (PTFE), polyvinylidene fluoride (PVDF)) and/or in the case of which the at least one thermosetting plastic is selected from the group of reaction resins (e.g. unsaturated polyester resins (UP resins), epoxide resins (EP resins), isocyanate resins, methacrylate resins (MA resins), phenacrylate resins (PHA resins) and/or condensation resins (e.g. phenol resins, amino resins, polyester resins).

10. The method according to claim 1, in the case of which between 25% by volume and 97% by volume, preferably between 45% by volume and 88% by volume, in particular between 53% by volume and 70% by volume, of the plastic composite material is formed by a, preferably electrically conductive, filler material.

11. The method according to claim 1,
in the case of which as the at least one filler material of the plastic composite material, carbon particles, in particular in the form of graphite, graphene, carbon nano tubes, carbon black and/or carbon fibres arc used and
in the case of which, preferably, the filler material at least substantially corresponds to the carbon particles for hydrophilicizing the at least one surface of the semi-finished element.

12. The method for manufacturing an electrode element, in particular an electrode plate, a bipolar element, in particular a bipolar plate, and/or a heat exchanger element, in particular a heat exchanger tube or a heat exchanger plate, from a semi-finished element,
in the case of which a semi-finished element hydrophilicized according to claim 1, is further processed into an electrode element, in particular an electrode plate, a bipolar element, in particular a bipolar plate, and/or a heat exchanger element, in particular a heat exchanger tube or a heat exchanger plate, and/or
in the case of which a semi-finished element is further processed into an electrode element, in particular an electrode plate, a bipolar element, in particular a bipolar plate, and/or a heat exchanger element, in particular a heat exchanger tube or a heat exchanger plate, and then is hydrophilicized according to claim 1.

13. The method according to claim 12,
in the case of which the electrode element is an electrode element of an electrochemical cell, in particular of a redox flow battery or
in the case of which the bipolar element is a bipolar element of an electrochemical cell, in particular of a redox flow battery.

14. An electrode element, in particular electrode plate, bipolar element, in particular bipolar plate, and/or heat exchanger element, in particular heat exchanger tube or heat exchanger plate, manufactured according to claim 12.

15. An electrochemical cell, in particular redox flow battery, with an electrode element, in particular electrode plate, or with a bipolar element, in particular bipolar plate, according to claim 14.
